(19) United States
(12) Patent Application Publication
(10) Pub. No.: US 2019/0154908 A1
(43) Pub. Date: May 23, 2019

(54) LIGHTING DEVICE AND DISPLAY DEVICE

(71) Applicant: SHARP KABUSHIKI KAISHA, Sakai City, Osaka (JP)

(72) Inventor: HIDEAKI YABUUCHI, Sakai City (JP)

(21) Appl. No.: 16/300,254

(22) PCT Filed: May 1, 2017
(86) PCT No.: PCT/JP2017/017145

§ 371 Date: Nov. 9, 2018

(30) Foreign Application Priority Data
May 11, 2016 (JP) 2016-095257

(51) Int. Cl. F21V 8/00; G02F 1/1333

(52) U.S. Cl. CPC G02B 6/0088; G02F 1/133308; G02F 2001/133334; G02F 2001/133317; G02F 2001/13332; G02F 2001/133314

(57) ABSTRACT

A backlight device 12 includes LEDs 15, a light guide plate 17, an inner frame-shaped portion 20b, a light guide late holding portion 24, an outer frame-shaped portion 21B, and elastic abutment portions 25. The light guide plate 17 includes an outer peripheral end surface. The outer peripheral end surface includes an end surface opposed to the LEDs 15 and defined as a light entering surface through which light from the LEDs 15 enters. The light guide plate 17 includes a pair of plate surfaces. One of the plate surfaces is defined as a light exiting plate surface 17b through which the light exits. The inner frame-shaped portion 20b is opposed to the outer peripheral end surface to surround the light guide plate 17. The light guide plate holding portion 24 is disposed between at least a part of the outer peripheral end surface of the light guide plate 17 and the inner frame-shaped portion 20b to hold the light guide plate 17. The outer frame-shaped portion 21b surrounds the inner frame-shaped portion 20b to overlap an outer side of the inner frame-shaped portion 20b. The elastic abutment portions 25 included in the light guide plate holding portion 24 are elastically abutted against the outer frame-shaped portion 21b.

### TECHNICAL FIELD

The present invention relates to a lighting device and a display device.

### BACKGROUND ART

A conventional liquid crystal display device is known from Patent Document 1 indicated below, for example. The liquid crystal display device disclosed in Patent Document 1 is provided with shield covers for shielding respective substrates, a rear cover disposed on the back surface side of the shield covers, and an elastic material that is attached to the rear cover and contacts the shield covers. Vibrations of the rear cover are suppressed by means of the elastic material.

### RELATED ART DOCUMENT

### Patent Document

Patent Document 1: Japanese Unexamined Patent Application Publication No. 2004-264571

### Problem to be Solved by the Invention

In the liquid crystal display device disclosed in Patent Document 1, a dedicated component (elastic material) is installed to suppress vibrations of the rear cover. Accordingly, the number of components is increased and thus the number of assembly steps is increased, resulting in an increase in manufacturing cost.

### DISCLOSURE OF THE PRESENT INVENTION

The present invention has been completed on the basis of the above circumstance, and an object of the present invention is to reduce cost.

### Means for Solving the Problem

A lighting device according to the present invention includes a light source, a light guide plate, an inner frame-shaped portion, a light guide plate, an outer frame-shaped portion, and at least one elastic abutment portion. The light guide plate includes an outer peripheral end surface and a pair of plate surfaces. The outer peripheral end surface includes an end surface opposed to the light source and defined as a light entering end surface through which light enters. One of the plate surfaces is defined as a light exiting plate surface through which the light exits. The inner frame-shaped portion is opposed to the outer peripheral end surface to surround the light guide plate. The light guide plate holding portion is disposed between at least a part of the outer peripheral end surfaces of the light guide plate and the inner frame-shaped portion to hold the light guide plate. The outer frame-shaped portion surrounds the inner frame-shaped portion to overlap an outer side of the inner frame-shaped portion. The elastic abutment portion is on the light guide plate holding portion and elastically abutted against the outer frame-shaped portion.

According to the configuration, the light emitted by the light source enters the light guide plate through the light entering end surface, travels through the light guide plate, exit the light guide plate through the light exiting plate surface. The light guide plate is held by the light guide plate holding portion disposed between at least a part of the outer peripheral end surfaces and the inner frame-shaped portion. If the inner frame-shaped portion and the outer frame-shaped portion are not tightly fitted because of assembly tolerances, the inner frame-shaped portion and the outer frame-shaped portion may generate noise when the lighting device vibrates. In this respect, the elastic abutment portion on the light guide plate holding portion disposed between at least a part of the outer peripheral end surfaces of the light guide plate and the inner frame-shaped portion is elastically abutted against the outer frame-shaped portion. Thus, the outer frame-shaped portion and the inner frame-shaped portion are less likely to generate noise. The elastic abutment portion on the light guide plate holding portion is an existing component. In comparison to the conventional configuration including a special component, the number of components and the number of assembly steps are decreased and thus cost can be reduced.

Preferred embodiments of the lighting device according to the present invention include the following configurations.

(1) The inner frame-shaped portion may include a through-hole. The elastic abutment portion may be abutted against the outer frame-shaped portion through the through-hole. Because the elastic abutment portion abutted against the outer frame-shaped portion is passed through the through-hole in the inner frame-shaped portion, the elastic abutment portion is locked on the hole edge of the through-hole. Therefore, the light guide plate holding portion is less likely to be detached.

(2) The light guide plate may include a corner portion defined by end surfaces included in the outer peripheral end surface. The end surfaces are perpendicular to each other. The light guide plate holding portion may include a first holding portion abutted against one of the end surfaces that define the corner port on and a second holding portion abutted against another one of the end surfaces. The first holding portion and the second holding portion may be connected to each other. The at least one elastic abutment portion may be on the first holding portion and the second holding portion. According to the configuration, the light guide plate is two-dimensionally held by means of the light guide plate holding portion having the configuration in which the first holding portion abutted against the one of the end surfaces that define the corner portion and the second holding portion abutted against the other one of the end surface are connected. The first holding portion and the second holding portion are connected to each other. Each of the first holding portion and the second holding portion of the light guide plate holding portion having the above configuration is provided with the elastic abutment portion. Thus, the inner frame-shaped portion and the outer frame-shaped portion are less likely to two-dimensionally contact each other. Because the elastic abutment portions are provided on the same light guide plate holding portion, the number of components and the number of assembly steps can be further reduced and thus the cost is further reduced.

(3) The lighting device may further include a light guide plate receiving portion and a light guide plate pressing portion. The light guide plate receiving portion is coupled with one of the inner frame-shaped portion and the outer frame-shaped portion to receive the light guide plate from a side opposite from the light exiting plate surface side. The light guide plate pressing portion is coupled with the other one of the inner frame-shaped portion and the outer frame-shaped portion to press the light guide plate from the light exiting plate surface side. According to the configuration, the light guide plate is received by the light guide plate receiving portion from the side opposite from the light exiting plate surface side and pressed by the light guide plate pressing portion from the light exiting plate surface side. Thus, the light guide plate is held with respect to a normal direction of the plate surface of the light guide plate.

(4) The light guide plate holding portion may include a pressing portion-side elastic abutment portion that protrudes from the light exiting plate surface of the light guide plate and may be abutted against the light guide plate pressing portion. According to the configuration, the pressing portion-side elastic abutment portion is abutted against the light guide plate pressing portion. Accordingly, the light guide plate pressing portion and one of the inner frame-shaped portion and the outer frame-shaped portion are less likely to contact each other with respect to the normal direction of the plate surface of the light guide plate. Therefore, noise is further properly reduced. In addition, the elastic abutment portion and the pressing portion-side elastic abutment portion are provided on the same light guide plate holding portion. Accordingly, the number of components and the number of assembly steps are further decreased and thus the cost be further reduced.

(5) Tie light guide plate receiving portion may be coupled with the inner frame-shaped portion. The light guide plate pressing portion may be coupled with the outer frame-shaped portion. The elastic abutment portion may include an inclined surface in an outer surface of the elastic abutment portion. The inclined surface is configured such that a distance from the outer frame-shaped portion decreases as a distance from the light exiting plate surface with respect to the normal direction of a plate surface of the light guide plate increases. During attachment of the light guide plate pressing portion coupled with the outer frame-shaped portion, the outer frame-shaped portion is guided by the inclined surface included in the outer surface of the elastic abutment portion. According to the configuration, higher assembly workability can be achieved.

(6) One of the inner frame-shaped portion and the outer frame-shaped portion may include a lock opening. The other one of the inner frame-shaped portion and the outer frame-shaped portion may include a locking nail portion disposed in the lock opening and locked on an opening edge of the lock opening. During attachment of the inner frame-shaped portion and the outer frame-shaped portion, the locking nail portion is inserted in the lock opening and locked on the opening edge of the lock opening. Therefore, the inner frame-shaped portion and the outer frame-shaped portion are fixed to each other. The internal dimension of the lock opening may be set greater than the outer dimension of the locking nail portion so that the locking nail portion properly enter even if an production error is present. In such a dimensional design, a difference in dimension may be present between the locking nail portion and the lock opening. Therefore, the inner frame-shaped portion and the outer frame-shaped portion may not be tightly fitted to each other. However, as described above, the elastic abutment portion included in the light guide plate holding portion is elastically abutted against the outer frame-shaped portion and thus the outer frame-shaped portion and the inner frame-shaped portion are less likely to generate noise.

In order to solve the problem, a display device according to the present invention includes the above lighting device and a display panel configured to display an image using light from the lighting device. According to the display device having such a configuration, production cost can be reduced because the cost of the lighting device configured to illuminate the display panel is reduced.

A preferred embodiment of the display device of the present invention may have the following configuration.

(1) The display device may further include a panel pressing member that presses the display panel from an opposite side to the lighting device side. The panel pressing member may include the outer frame-shaped portion. According to the configuration, even in the configuration in which the panel pressing member that presses the display panel from the opposite side to the lighting device side includes the outer frame-shaped portion, due to the elastic abutment portion on the light guide plate holding portion being elastically abutted against the outer frame-shaped portion, the outer frame-shaped portion and the inner frame-shaped portion are less likely to generate noise.

### Advantageous Effect of the Invention

According to the present invention, cost can be reduced.

### BRIEF DESCRIPTION OF THE DRAWINGS

FIG. 1 is a planar cross sectional view of a backlight device provided in a liquid crystal display device according to the first embodiment of the present invention.

FIG. 2 is a cross sectional view taken along line A-A of FIG. 1.

FIG. 3 is a cross sectional view taken along line B-B of FIG. 1.

FIG. 4 is an enlarged planar cross sectional view of the vicinity of a corner portion of a light guide plate in FIG. 1.

FIG. 5 is a cross sectional view taken along line C-C of FIG. 4.

FIG. 6 is a cross sectional side view of a liquid crystal display device according to the second embodiment of the present invention.

FIG. 7 is a cross sectional view of a section of an elastic abutment portion of a backlight device provided in a liquid crystal display device.

FIG. 8 is a cross sectional view of a section of an elastic abutment portion of a backlight device provided in a liquid crystal display device according to the third embodiment of the present invention.

### MODE FOR CARRYING OUT THE INVENTION

### First Embodiment

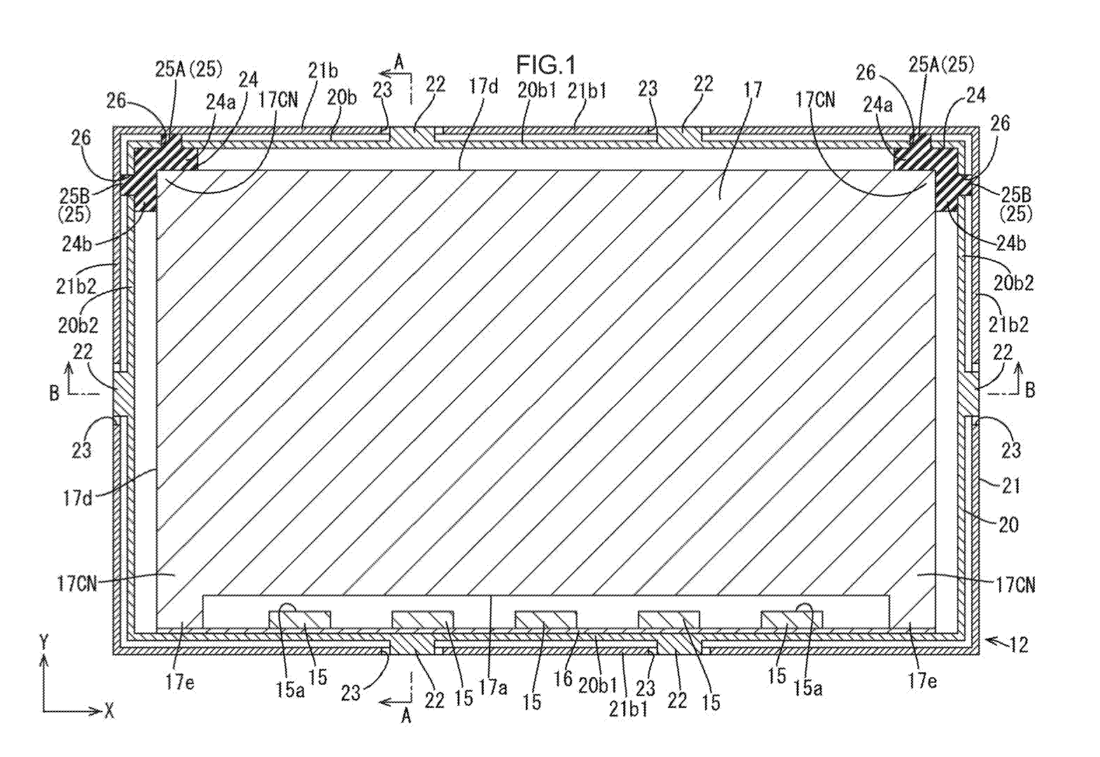

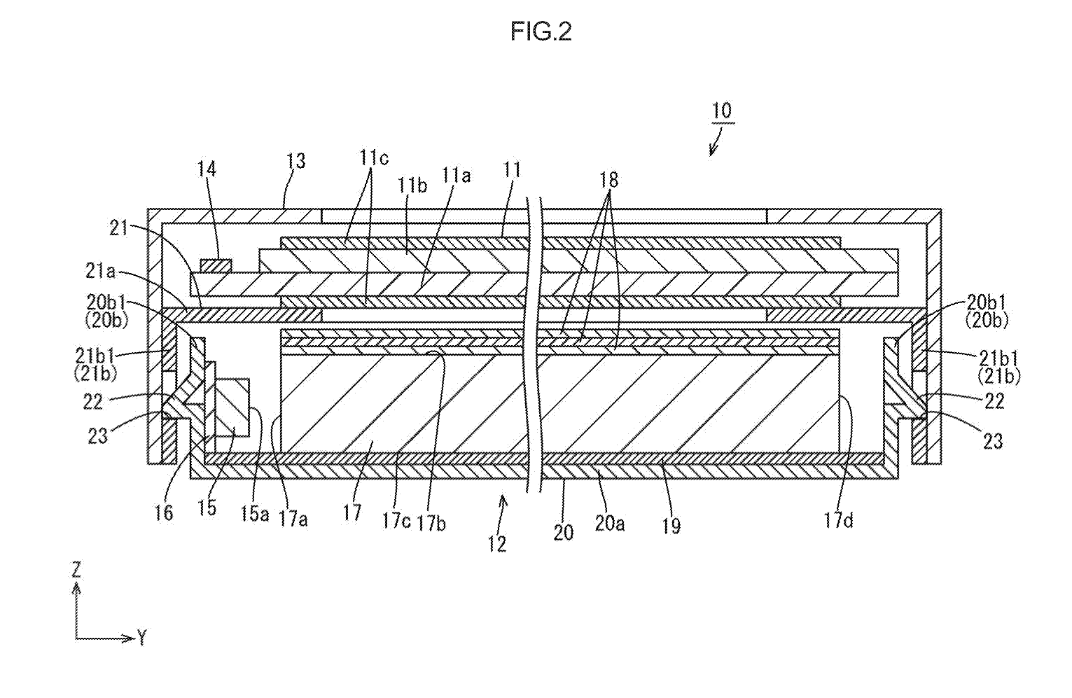

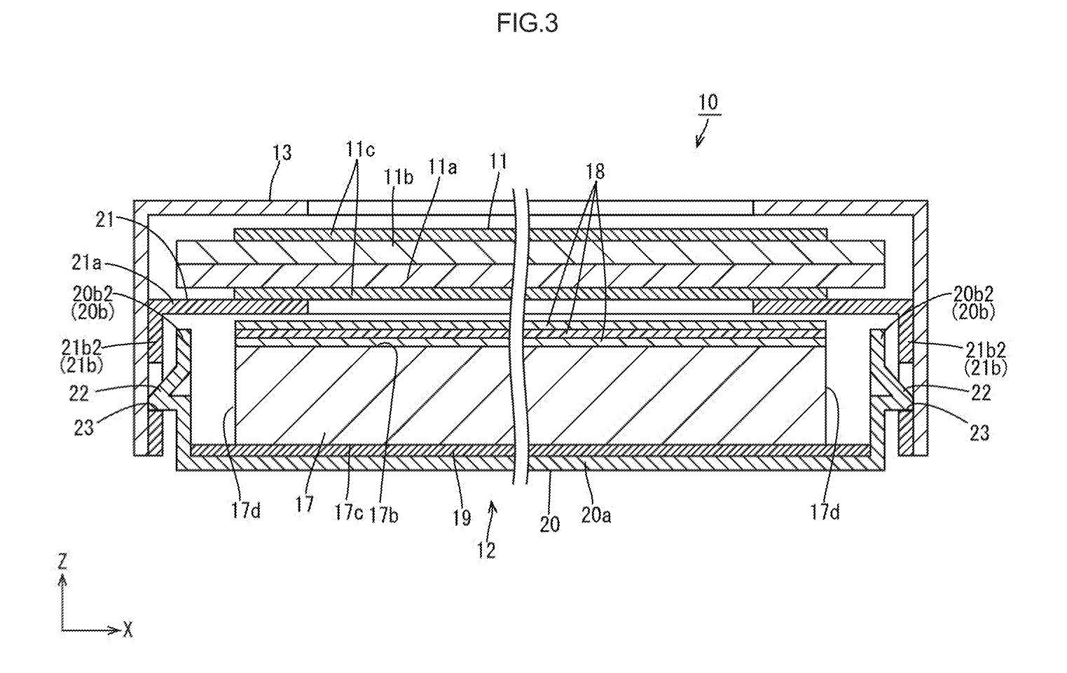

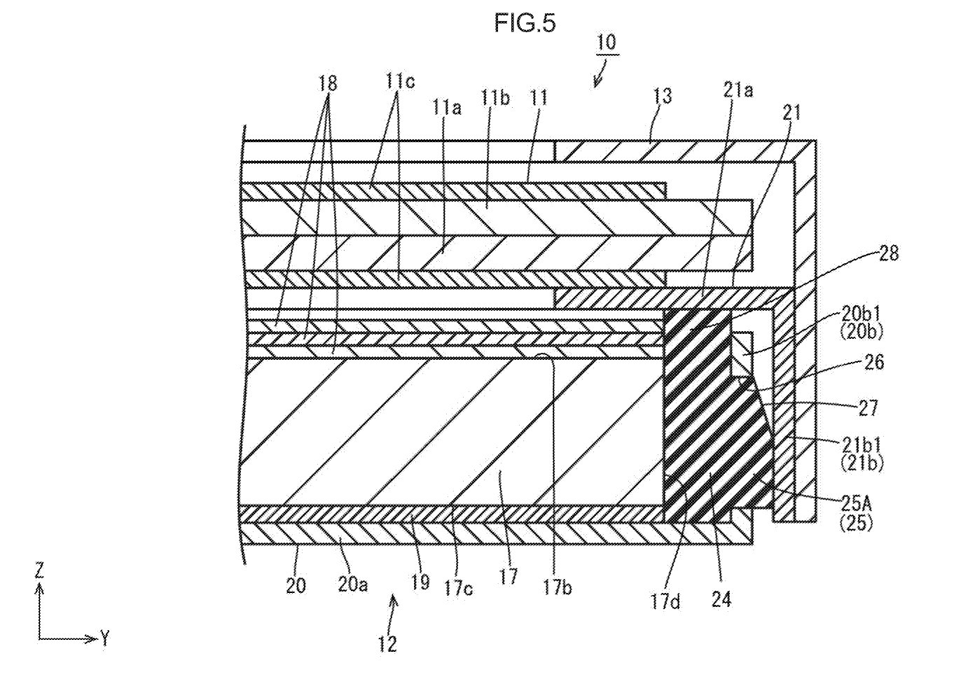

A first embodiment of the present invention will be described with reference to FIG. 1 to FIG. 5. In the present embodiment, a backlight device 12 and a liquid crystal display device 10 using the same will be described by way of example. In a part of each of the drawings, an X-axis, a Y-axis, and a Z-axis are shown, the respective axis directions corresponding to the directions illustrated in the drawings. The top of FIG. 2, FIG. 3, and FIG. 5 corresponds to the front side, and the bottom thereof corresponds to the back side.

The liquid crystal display device (display device) 10, as illustrated in FIG. 2, is provided with a liquid crystal panel (display panel) 11 for displaying an image, and a backlight device (lighting device) 12 that supplies the liquid crystal panel 11 with light for display. The liquid crystal panel 11 and the backlight device 12 are configured to be integrally held by means of a frame-shaped bezel 13 and the like. The liquid crystal display device 10 is preferably for mounting on a vehicle. Specifically, the liquid crystal display device 10 may be used for displaying, for example, a map image in a car navigation system or an image captured by a vehicle-mounted camera. The liquid crystal display device 10 may also be used for displaying various meters (such as a speedometer and a tachometer), or various warning images (such as an airbag warning lamp, an engine warning lamp, and a seat be non-wearing warning lamp) on the instrument panel.

The liquid crystal panel 11, as illustrated in FIG. 2 and FIG. 3, has a configuration in which a pair of substantially transparent substrates 11a, 11b made of glass is bonded to each other with a predetermined gap therebetween, and in which liquid crystal is sealed between the substrates 11a, 11b. Of the pair of substrates 11a, 11b, the array substrate 11a disposed on the back side is provided with switching elements (such as TFTs) connected to source wires and gate wires that are perpendicular to each other, pixel electrodes connected to the switching elements, an alignment film and the like. The CF substrate 11b disposed on the front side is provided with a color filter in which colored portions of red (R), green (G), blue (B) and the like are arranged in a predetermined arrangement, counter electrodes, an alignment film and the like. On the array substrate 11a, a driver 14 for driving the liquid crystal panel 11 and a flexible substrate (not illustrated) are mounted. Front and back polarizing plates 11c are attached to the outer surfaces of the substrates 11a and 11b, respectively.

The backlight device 12, as illustrated in FIG. 1 and FIG. 2, has a generally horizontally long rectangular shape when viewed in plan. The backlight device 12 includes light emitting diodes (LEDs) 15, an LED substrate (a light source substrate) 16 on which the LEDs 15 are mounted, a light guide plate 17, optical sheets (an optical member) 18, and a reflection sheet (a reflection member) 19. The light guide plate 17 guides light from the LEDs 15. The optical sheets 18 are disposed on top of each other on the front side of the light guide plate 17. The reflection sheet 19 is disposed on top of each other on the back side of the light guide plate 17. The backlight device 12 is further provided with a chassis (light guide plate receiving member) 20 in which the members 15 to 19 are contained, and a frame (light guide plate pressing member) 21 that presses the sheets contained in the chassis 20 (the light guide plate 17, the optical sheets 18, and the reflection sheet 19) from the front side. The sheets including the light guide plate 17 are sandwiched between the chassis 20 and the frame 21 from the front and back with respect to the Z-axis direction (normal direction of the plate surface of the sheets), and are thereby held. The backlight device 12 is of one-side light entry, edge-lit type (side light type). In this type, the LEDs 15 (LED substrate 16) are eccentrically disposed closer to one end portion with respect to the short-side direction (the Y-axis direction) of the backlight device 12, and the light enters the light guide plate 17 only from one side. In the following, the constituent components of the backlight device 12 will be described in sequence.

The LEDs 15, as illustrated in FIG. 1 and FIG. 2, have a configuration in which LED chips are sealed, using a sealing material, on a substrate portion fixedly attached to the LED substrate 16. The LEDs 15 are configured such that the LED chips emit a single color of light, such as blue light. In the sealing material, fluorescent materials (such as a yellow fluorescent material, a green fluorescent material, and a red fluorescent material) are dispersed and compounded to emit generally white light. In the LEDs 15, the surface on the opposite side from the surface mounted to the LED substrate 16 provides a light-emitting surface 15a. That is, the LEDs 15 are of the so-called top light-emitting type.

The LED substrate 16, as illustrated in FIG. 1 and FIG. 2, is made of a film-like insulating base material, and the mounting surface to which the LEDs 15 are mounted is disposed opposite an end surface of the light guide plate 17. The LED substrate 16 is attached to the chassis 20, with a plate surface on the opposite side from the mounting surface for the LEDs 15 contacting an inner surface of an inner frame-shaped portion 20b, which will be described later, of the chassis 20. Of the LED substrate 16, the mounting surface for the LEDs 15 is patterned with a wiring pattern (not illustrated) for supplying power to the LEDs 15. LEDs 15 are mounted side by side at intervals in the X-axis direction.

The light guide plate 17 is made of a synthetic resin material that is substantially transparent and has a refractive index sufficiently higher than that of air (for example, acrylic resin such as PMMA and polycarbonate). The light guide plate 17, as illustrated in FIG. 1 and FIG. 2, is housed in the chassis 20 and disposed immediately under the liquid crystal panel 11 and the optical sheets 18. The light guide plate 17 when viewed in plan has a horizontally long rectangular shape, and includes corner portions 17CN at the four corners. The light guide plate 17 includes an outer peripheral end surface. The outer peripheral end surface includes a pair of short end surfaces and a pair of long end surfaces. The pairs are perpendicular to each other. Each of the corner portions 17CN is defined by a short end surface and a long end surface that are adjacent to each other. One of the long end surfaces in the outer peripheral end surface of the light guide plate 17 (on the lower side in FIG. 1, on the left side in FIG. 2) includes a light entering end surface (light source-opposing end surface) 17a opposed to the LEDs 15 and through which light from the LEDs 15 directly enters. The remaining three end surfaces (the other long end surface and the pair of short end surfaces) constitute non-light entering end surfaces (light source non-opposing end surfaces) 17d that do not oppose the LEDs 15 and via which the light from the LEDs 15 does not directly enter. The light guide plate 17 includes a pair of front and back plate surfaces. One of the plate surfaces facing the front side (the liquid crystal panel 11 side) is defined as a light exiting plate surface 17b through which light exits toward the liquid crystal panel 11. The other one of the plate surfaces facing the back side is defined as an opposite plate surface 17c on the opposite side from the light exiting plate surface 17b. The light guide plate 17 has the function of: receiving light emitted by the LEDs 15 in the Y-axis direction the light entering end surface 17a through the light entering end surface; and directing the light traveling through the light guide plate 17 in the Z-axis direction to exit the light guide plate 17 through the light exiting plate surface 17b toward the optical sheets 18 (on the front side, the light exiting side). As illustrated in FIG. 1, at both ends in the length direction (the X-axis direction) of the light entering end surface 17a of the light guide plate 17 (the pair of corner portions 17CN on the LED 15 side with respect to the normal direction (the Y-axis direction) of the light entering end surface 17a), a pair of position regulating portions 17e protrude toward the LED substrate 16. The pair of position regulating portions 17e, by being interposed between the light entering end surface 17a of the light guide plate 17, and the LED substrate 16 and the inner frame-shaped portion 20b of the chassis 20, regulates the position relationship between the light entering end surface 17a and the LEDs 15. According to the configuration, even if thermal expansion is caused in the light guide plate 17, the light entering end surface 17a can be prevented from interfering with the LEDs 15.

The optical sheets 18, as illustrated in FIG. 2, is interposed between the liquid crystal panel 11 and the light guide plate 17 with respect to the Z-axis direction, with a plate surface of the optical sheets 18 being parallel with a plate surface of, e.g., the light guide plate 17. The optical sheets 18 have the function for exerting optical effects on the light from the light guide plate 17 to toward the liquid crystal panel 11. The optical sheets 18 include sheets (three in the present embodiment) which are laminated upon each other.

The reflection sheet 19, as illustrated in FIG. 2, is disposed to cover the opposite plate surface 17c of the light guide plate 17, with a plate surface of the reflection sheet 19 being parallel with a plate surface of, e.g., the light guide plate 17. The reflection sheet 19 has excellent optical reflectivity, and is configured to cause light that has leaked from the opposite plate surface 17c of the light guide plate 17 to efficiently rise toward the front side (light exiting plate surface 17b). The reflection sheet 19 has an outer shape slightly larger than the light guide plate 17, and is disposed with the end portion thereof on the side of one long side projecting on the LED 15 side beyond the light entering end surface 17a.

The chassis 20 is made of metal and, as illustrated in FIG. 1 and FIG. 2, includes: a light guide plate receiving portion 20a for receiving sheets, such as the light guide plate 17 from the back side; and an inner frame-shaped portion 20b that protrudes from the outer peripheral ends of the light guide plate receiving portion 20a toward the front side (light exiting side), and forms a short cylindrical shape. Generally, the inner frame-shaped portion 20b has a shallow, substantially box-like shape with an opening toward the front side. The light guide plate receiving portion 20a, when viewed in plan, has a horizontally long rectangular shape, similarly to the sheets, such as the light guide plate 17. The size of the light guide plate receiving portion 20a, as viewed in plan, is slightly larger than the light guide plate 17. The inner frame-shaped portion 20b when viewed in plan has a horizontally long and rectangular frame-like shape, and includes a pair of long-side portions 20b1 and a pair of short-side portions 20b2, the pairs being perpendicular to each other. The inner frame-shaped portion 20b surrounds the light guide plate 17, and has, along the entire periphery, inner peripheral surfaces opposing the outer peripheral end surface of the light guide plate 17.

The inner frame-shaped portion 20b, as illustrated in FIG. 2 and FIG. 3, is provided with locking nail portions 22 for fixing the frame 21. The locking nail portions 22 are formed by partially punching out the inner frame-shaped portion 20b to protrude outward beyond the outer surface thereof. The locking nail portions 22, as illustrated in FIG. 1, are arranged one in the vicinity of the center in the length direction of each of the pair of short-side portions 20b2 configuring the inner frame-shaped portion 20b, and two at two locations sandwiching the center in the length direction of the pair of long-side portions 20b1. The LED substrate 16 is attached to one of the long-side portions 20b1 of the inner frame-shaped portion 20b, as noted above.

The frame 21 is made of metal, similarly to the chassis 20. As illustrated in FIG. 1 and FIG. 2, the frame 21 includes: a light guide plate pressing portion 21a that presses the sheets, such as the light guide plate 17 from the front side; and an outer frame-shaped portion 21b that protrudes from the outer peripheral ends of the light guide plate pressing portion 21a toward the back side (the opposite side from the light exiting side), forming a short cylindrical shape. Generally, the frame 21 has a horizontally long frame-like shape. The light guide plate pressing portion 21a has a frame shape with a certain width with each side having an internal dimension smaller than the length of each side of the sheets, such as the light guide plate 17, and with each side having an outer dimension greater than the length of each side of the sheets, such as the light guide plate 17. The light guide plate pressing portion 21a presses the outer peripheral end portions of the sheets, such as the light guide late 17 (or, directly, the optical sheets 18 at the top) along the entire periphery from the front side. The outer frame-shaped portion 21b, when viewed in plan, has a horizontally long and rectangular frame-like shape, and includes a pair of long-side portions 21b1 and a pair of short-side portions 21b2, the pairs being perpendicular to each other. The outer frame-shaped portion 21b surrounds the inner frame-shaped portion 20b to overlap the outer side of the inner frame-shaped portion 20b, with inner peripheral surfaces opposing the outer peripheral surfaces of the inner frame-shaped portion 20b along the entire periphery. Between the outer frame-shaped portion 21b and the inner frame-shaped portion 20b, a gap is provided to absorb assembly tolerances between the frame 21 and the chassis 20. Thus, the ease of assembly of the frame 21 to the chassis 20 is ensured.

The outer frame-shaped portion 21b, as illustrated in FIG. 2 and FIG. 3, is provided with lock openings 23 for fixing the frame 21 to the chassis 20. The lock openings 23 are through-holes penetrating through the outer frame-shaped portion 21b in the plate thickness direction. The lock openings 23 are configured such that the locking nail portions 22 of the chassis 20 enter the lock openings 23 and become locked on the back side portion of the opening edge. The dimensions of the lock openings 23 are designed such that their internal dimensions are greater than the outer dimension of the locking nail portions 22. Accordingly, even if a manufacturing error is caused, the locking nail portions 22 can enter the lock openings 23 reliably and provide a fixing function. The lock openings 23, as illustrated in FIG. 1, have an arrangement in the outer frame-shaped portion 21b with respect to the circumferential direction that is aligned with an arrangement of the locking nail portions 22 in the inner frame-shaped portion 20b with respect to the circumferential direction. Specifically, one lock opening 23 is provided in the vicinity of the center in the length direction of each of the pair of short-side portions 21b2 configuring the outer frame-shaped portion 21b, and two lock openings 23 are provided at two locations sandwiching the center in the length direction of each of the pair of long-side portions 21b1. The light guide plate pressing portion 21a supports the outer peripheral end portions of the liquid crystal panel 11 from the back side, and may be considered a “liquid crystal panel support portion”.

The backlight device 12 according to the present embodiment, as illustrated in FIG. 1, includes light guide plate holding portions 24 that are disposed between end surfaces of the light guide plate 17 and the inner frame-shaped portion 20b of the chassis 20 to hold the light guide plate 17. The light guide plate holding portions 24 are made of an elastic material (such as rubber material), and elastically contact the light guide plate 17 and the inner frame-shaped portion 20b, so that the light guide plate 17 can be stably held. The light guide plate holding portions 24 when viewed in plan have a substantially L-shape in conformity to the corner portions 17CN of the light guide plate 17. Specifically, the light guide plate holding portions 24 include first holding portions 24a that are abutted against the end surface on (one) long side of the corner portions 17CN of the light guide plate 17, and second holding portions 24b abutted against the end surface on the (other) short side adjacent to the long end surface, the first holding portions 24a and the second holding portions 24b being connected with each other. The first holding portions 24a are interposed between the long end surface of the light guide plate 17 and the long-side portions 20b1 of the inner frame-shaped portion 20b to hold the light guide plate 17 with respect to the Y-axis direction. The second holding portions 24b are interposed between the short end surface of the light guide plate 17 and the short-side portions 20b2 of the inner frame-shaped portion 20b to hold the light guide plate 17 with respect to the X-axis direction. Accordingly, the light guide plate holding portions 24 hold the light guide plate 17 two-dimensionally with respect to the X-axis direction and the Y-axis direction along the plate surface thereof. A pair of the light guide plate holding portions 24 is arranged to respectively hold, of the corner portions 17CN at the four corners of the light guide plate 17, a pair of corner portions 17CN on the opposite side from the side on which the pair of position regulating portions 17e is installed (the light entering end surface 17a side) with respect to the Y-axis direction. The three end surfaces of the outer peripheral end surface of the light guide plate 17 abutted against the light guide plate holding portions 24 are defined as non-light entering end surfaces 17d. In other words, the light guide plate holding portions 24 are disposed to be abutted against all of the outer peripheral end surfaces of the light guide plate 17 except for the light entering end surface 17a.

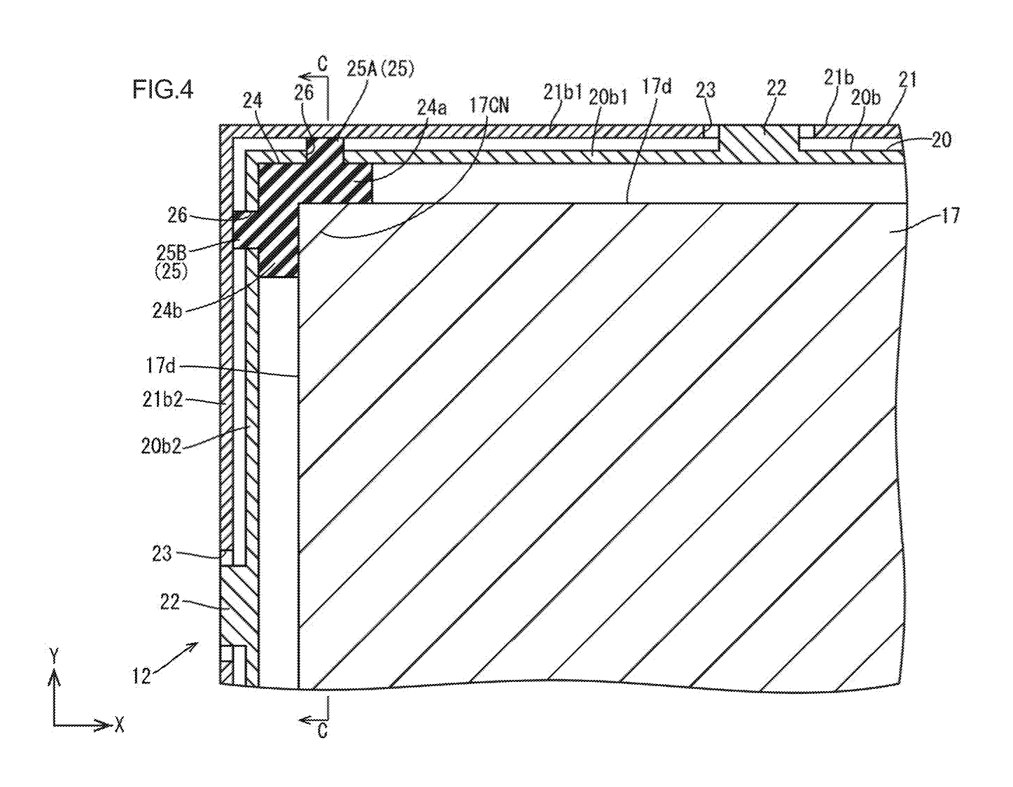

The light guide plate holding portions 24, as illustrated in FIG. 4 and FIG. 5, are provided with elastic abutment portions 25 that are elastically abutted against the outer frame-shaped portion 21b of the frame 21. The elastic abutment portions 25 are made of the same elastic material (such as rubber material) as that of the light guide late holding portions 24, and are integrally formed with the light guide plate holding portions 24. The elastic abutment portions 25 are provided so as to protrude outward from an outer surface of the light guide plate holding portions 24 that opposes the inner frame-shaped portion 20b. In the present embodiment, the inner frame-shaped portion 20b interposed between the outer frame-shaped portion 21b against which the elastic abutment portions 25 are abutted and the light guide plate holding portions 24 provided with the elastic abutment portions 25 is provided with through-holes 26. The elastic abutment portions 25 are passed through the through-holes 26, whereby the abutting of the elastic abutment portions 25 against the outer frame-shaped portion 21b is achieved. The through-holes 26 penetrate through the inner frame-shaped portion 20b in the plate thickness direction thereof, with the hole edge forming an endless annular shape. The through-holes 26 have an internal dimension that is substantially the same as or slightly greater than the outer dimension of the elastic abutment portions 25. According to the configuration, the outer peripheral surface of the elastic abutment portions 25 that is passed through the through-holes 26 is abutted (intimately attached) on the hole edge (particularly the front side part) of the through-holes 26 substantially along the entire periphery thereof, whereby the light guide plate holding portions 24 is held onto (prevented from becoming detached from) the chassis 20 with respect to the Z-axis direction. The elastic abutment portions 25 and the through-holes 26 have a rectangular shape as viewed laterally. The dimension of protrusion of the elastic abutment portions 25 from the outer surface of the light guide plate holding portions 24 is the same or greater than a dimension obtained by summing the plate thickness dimension of the inner frame-shaped portion 20b and the distance between the inner frame-shaped portion 20b and the outer frame-shaped portion 21b (the dimension of the gap provided therebetween). Accordingly, the elastic abutment portions 25 elastically hold the inner frame-shaped portion 20b and the outer frame-shaped portion 21b in a state in which a gap is provided between the mutually opposing surfaces, so that the inner frame-shaped portion 20b and the outer frame-shaped portion 21b are less likely to interfere with each other.

According to the configuration, the elastic abutment portions 25, with which the light guide plate holding portions 24 interposed between the end surface of the light guide plate 17 and the inner frame-shaped portion 20b are provided, are elastically abutted against the outer frame-shaped portion 21b. Accordingly, when looseness due to assembly tolerances or looseness due to dimensional differences between the locking nail portions 22 and the lock openings 23 develops between the chassis 20 and the frame 21 and vibrations are caused in the liquid crystal display device 10, the outer frame-shaped portion 21b and the inner frame-shaped portion 20b are less likely to contact each other (interfere with each other), whereby the generation of noise (metal interference noise) is suppressed. In particular, the liquid crystal display device 10 according to the present embodiment is for vehicle-mounted purposes and is frequently subjected to vibrations such as road noise. However, the contact between the outer frame-shaped portion 21b and the inner frame-shaped portion 20b can be preferably suppressed by means of the elastic abutment portions 25, whereby quietness in the internal space of the vehicle can be achieved. The elastic abutment portions 25 are provided on the light guide plate holding portions 24, which are existing components. Accordingly, compared with the conventional case in which dedicated components are installed, the number of components and the number of assembly steps are respectively decreased, thus achieving cost reduction.

Specifically, the elastic abutment portions 25, as illustrated in FIG. 4, respectively provided on first holding portions 24a. and second holding portions 24b that are perpendicular to each other in the light guide plate holding portions 24 to form an L-shape in a plan view. In the following the elastic abutment portions 25 provided on the first holding portions 24a. will be referred to as “first elastic abutment portions 25A”, and the elastic abutment portions 25 provided on the second holding portions 24b will be referred to as “second elastic abutment portions 25B”. The first elastic abutment portions 25A are abutted against the long-side portion 21b1 of the outer frame-shaped portion 21b. Thus, the long-side portion 21b1 is less likely to contact the long-side portion 20b1 of toe inner frame-shaped portion 20b. The second elastic abutment portions 25B are abutted against the short-side portions 21b2 of the outer frame-shaped portion 21b. Thus, the short-side portions 21b2 are less likely to contact the short-side portions 20b2 of the inner frame-shaped portion 20b. As described above, the first elastic abutment portions 25A and the second elastic abutment portions 25B are respectively provided on the first holding portions 24a and the second holding portions 24b. Accordingly, the inner frame-shaped portion 20b and the outer frame-shaped portion 21b are less likely to two-dimensionally contact each other with respect to the X-axis direction and the Y-axis direction. Because the elastic abutment portions 25A, 25B are provided on the same light guide plate holding portions 24, the number of components and the number of assembly steps are further decreased, whereby a further cost reduction can be achieved.

The elastic abutment portions 25, as illustrated in FIG. 5, include an inclined surface 27 on an outer surface thereof. The inclined surface 27 is inclined such that the distance from the outer frame-shaped portion 21b becomes smaller with increasing distance from the light exiting plate surface 17b with respect to the Z-axis direction (normal direction of the plate surface of the light guide plate 17). In other words, the amount of protrusion of the elastic abutment portions 25 from the outer surface of the light guide plate holding portions 24 is varied in accordance with the position with respect to the Z-axis direction. Specifically, the amount of protrusion is minimized to approximately the plate thickness of the inner frame-shaped portion 20b at the front end position closest to the light exiting plate surface 17b with respect to the Z-axis direction. From there, the amount of protrusion is continuously and gradually increased with deceasing distance to the opposite plate surface 17c with respect to the Z-axis direction (with increasing distance from the light exiting plate surface 17b). The amount of protrusion has a maximum value before reaching the light exiting place surface 17b. Due to the provision of the inclined surface 27 with such configuration for the elastic abutment portions 25, when the frame 21 is assembled to cover the chassis 20 from the front side, the distal end portion of the outer frame-shaped portion 21b slides on the inclined surface 27, whereby the advancing operation of the frame 21 is guided. According to the configuration, the frame 21 can be attached to the chassis 20 with improved assembly workability.

The elastic abutment portions 25, as illustrated in FIG. 5, are provided with a pressing portion-side elastic abutment portion 28 that protrudes from the light exiting plate surface 17b of the light guide plate 17 in the Z-axis direction (normal direction of the plate surface of the light guide plate 17) toward the front side, and is abutted against the light guide plate pressing portion 21a of the frame 21. Specifically, the pressing portion-side elastic abutment portion 28 protrudes on the front side further beyond the optical sheets 18 at the top, and is abutted against the back side surface of the light guide plate pressing portion 21a, i.e., against the surface opposing the sheets, such as the light guide plate 17. According to the configuration, the light guide plate pressing portion 21a and the inner frame-shaped portion 20b of the chassis 20 are less likely to contact each other with respect to the Z-axis direction, whereby the generation of noise is more preferably suppressed. Because the elastic abutment portions 25 and the pressing portion-side elastic abutment portion 28 are provided on the same light guide plate holding portions 24, the number of components and the number of assembly steps are further decreased, whereby a further decrease in cost is achieved.

As described above, the backlight device (lighting device) 12 according to the present embodiment includes the LEDs (light source) 15, the light guide plate 17, the inner frame-shaped portion 20b, the light guide plate holding portion 24, the outer frame-shaped portion 21b, and the elastic abutment portions 25. The light guide plate 17 includes the peripheral end surface that includes the end surface defined as the light entering end surface 17a through which light enters. The end surface is opposed to the LEDs 15. The light exiting plate surface 17b is one of the plate surfaces through which the light exits. The inner frame-shaped portion 20b is opposed to the outer peripheral end surface that surrounds the light guide plate 17. The light guide plate holding portions 24 are disposed between at least a part of the outer peripheral end surfaces of the light guide plate 17 and the inner frame-shaped portion 20b to hold the light guide plate 17. The outer frame-shaped portion 21b surrounds the inner frame-shaped portion 20b to overlap the outer side of the inner frame-shaped portion 20b. The elastic abutment portions 25 are on the light guide plate holding portions 24 and elastically abutted against the outer frame-shaped portion 21b.

According to the configuration, the light emitted by the LEDs 15 enters the light entering end surface 17a of the light guide plate 17, travels through the light guide plate 17, and then exits the light guide plate 17 through the light exiting plate surface 17b. The light guide plate 17 is held by means of the light guide plate holding portions 24 interposed between at least a part of the outer peripheral end surfaces thereof and the inner frame-shaped portion 20b. If looseness due to assembly tolerances and the like is present between the inner frame-shaped portion 20b and the outer frame-shaped portion 21b, the inner frame-shaped portion 20b and the outer frame-shaped portion 21b may contact each other when the backlight device 12 is vibrated, resulting in the generation of noise. In this respect, the elastic abutment portions 25 provided on the light guide plate holding portions 24 interposed between at least a part of the outer peripheral end surfaces of the light guide plate 17 and the inner frame-shaped portion 20b is elastically abutted against the outer frame-shaped portion 21b. Thus, the outer frame-shaped portion 21b and the inner frame-shaped portion 20b are less likely to contact each other, and the generation of noise is suppressed. The elastic abutment portions 25 are provided on the light guide plate holding portions 24, which are existing components Accordingly, compared with the conventional case in which dedicated components are installed, the number of components and the number of assembly steps are respectively decreased, thus achieving cost reduction.

The inner frame-shaped portion 20b is provided with the through-holes 26, and the elastic abutment portions 25 are abutted against the outer frame-shaped portion 21b via the through-holes 26. Because the elastic abutment portions 25 abutted against the outer frame-shaped portion 21b are passed through the through-holes 26 in the inner frame-shaped portion 20b, the elastic abutment portions 25 are locked on the hole edge of the through-holes 26. Therefore, the light guide plate holding portions 24 are less likely to be detached.

The light guide plate 17 includes the corner portions 17CN defined by the end surfaces included in the outer peripheral end surface and perpendicular to each other. The light guide plate holding portions 24 include the first holding portions 24a that is abutted against one end surface of the end surfaces that define the corner portions 17CN, and the second holding portions 24b abutted against the other end surface, the first holding portions 24a and the second holding portions 24b being connected to each other. The elastic abutment portions 25 are respectively provided on the first holding portions 24a and the second holding portions 24b. According to the configuration, the light guide plate 17 is two-dimensionally held by the light guide plate holding portions 24 having the configuration in which the first holding portions 24a abutted against one end surface among a pair r of end surfaces configuring the corner portions 17CN, and the second holding portions 24b abutted against_{—} the other end surface are connected. Thus, the light guide plate holding portions 24 are configured such that the first holding portions 24a and the second holding portions 24b are respectively provided with the elastic abutment portions 25, whereby the inner frame-shaped portion 20b and the outer frame-shaped portion 21b are less likely to contact each other two-dimensionally. Because the elastic abutment portions 25 are provided on the same light guide plate holding portions 24, the number of components and the number of assembly steps are further decreased, whereby a further decrease in cost can be achieved.

The light guide plate receiving portion 20a is continuous with one of the inner frame-shaped portion 20b and the outer frame-shaped portion 21b, and receives the light guide plate 17 from opposite side from the light exiting plate surface 17b side. The light guide plate pressing portion 21a is continuous with the other of the inner frame-shaped portion 20b and the outer frame-shaped portion 21b and presses the light guide plate 17 from the light exiting plate surface 17b side. According to the configuration, the light guide plate 17 is received by the light guide plate receiving portion 20a from the side opposite from the light exiting plate surface 17b side and pressed by the light guide plate pressing portion 21a from the light exiting plate surface 17b side. The light guide plate 17 is held with respect to the normal direction of the plate surface thereof.

The light guide plate holding portions 24 are provided with the pressing portion-side elastic abutment portion 28 that protrudes from the light exiting plate surface 17b of the light guide plate 17 and is abutted against the light guide plate pressing portion 21a. With the pressing portion-side elastic abutment portion 28 abutted against the light guide plate pressing portion 21a, the light guide plate pressing portion 21a and one of the inner frame-shaped portion 20b and the outer frame-shaped portion 21b are less likely to contact each other with respect to the normal direction of the plate surface of the light guide plate 17. Therefore, noise is more preferably suppressed. In addition, the elastic abutment portions 25 and the pressing portion-side elastic abutment portion 28 are provided on the same light guide plate holding portions 24. Accordingly, the number of components and the number of assembly steps are further decreased, whereby a further decrease in cost can be achieved.

The light guide plate receiving portion 20a is continuous with the inner frame-shaped portion 20b, and the light guide plate pressing portion 21a is continuous with the outer frame-shaped portion 21b. On the outer surface of the elastic abutment portions 25, there is provided the inclined surface 27 of which the distance from the outer frame-shaped portion 21b becomes smaller with increasing distance from the light exiting plate surface 17b with respect to the normal direction of the plate surface of the light guide plate 17. According to the configuration, when the light guide plate pressing portion 21a continuous with the outer frame-shaped portion 21b is assembled, the outer frame-shaped portion 21b is guided by the inclined surface 27 provided on the outer surface of the elastic abutment portions 25, resulting in improved assembly workability.

One of the inner frame-shaped portion 20b and the outer frame-shaped portion 21b includes the lock openings 23. The other one of the inner frame-shaped portion 20b and the outer frame-shaped portion 21b includes the locking nail portions 22 that are inserted in the lock openings 23 and locked on the opening edge of the lock openings 23. According to the configuration, during the attachment of the inner frame-shaped portion 20b and the outer frame-shaped portion 21b, the locking nail portions 22 are inserted the lock openings 23 and locked on the opening edge of the lock openings 23. Therefore, the inner frame-shaped portion 20b and the outer frame-shaped portion 21b are fixed together. Preferably, the internal dimension of the lock openings 23 is set to be greater than the outer dimension of the locking nail portions 22 such that, even when a manufacturing error is caused, the locking nail portions 22 can enter reliably. In such dimension designing, a dimensional difference may be caused between the locking nail portions 22 and the lock openings 23, and, as a result, the inner frame-shaped portion 20b and the outer frame-shaped portion 21b may easily become loose. However, as described above, the elastic abutment portions 25 provided on the light guide plate holding portions 24 are elastically abutted against the outer frame-shaped portion 21b, whereby the outer frame-shaped portion 21b and the inner frame-shaped portion 20b are less likely to contact each other, and the generation of noise is suppressed.

The liquid crystal display device (display device) 10 according to the present embodiment is provided with the backlight device 12 described above, and the liquid crystal panel (display panel) 11 that displays an image using the light irradiated from the backlight device 12. With the liquid crystal display device 10 having such configuration, due to the decrease in cost of the backlight device 12 for irradiating the liquid crystal panel 11 with light, manufacturing cost is reduced.

### Second Embodiment

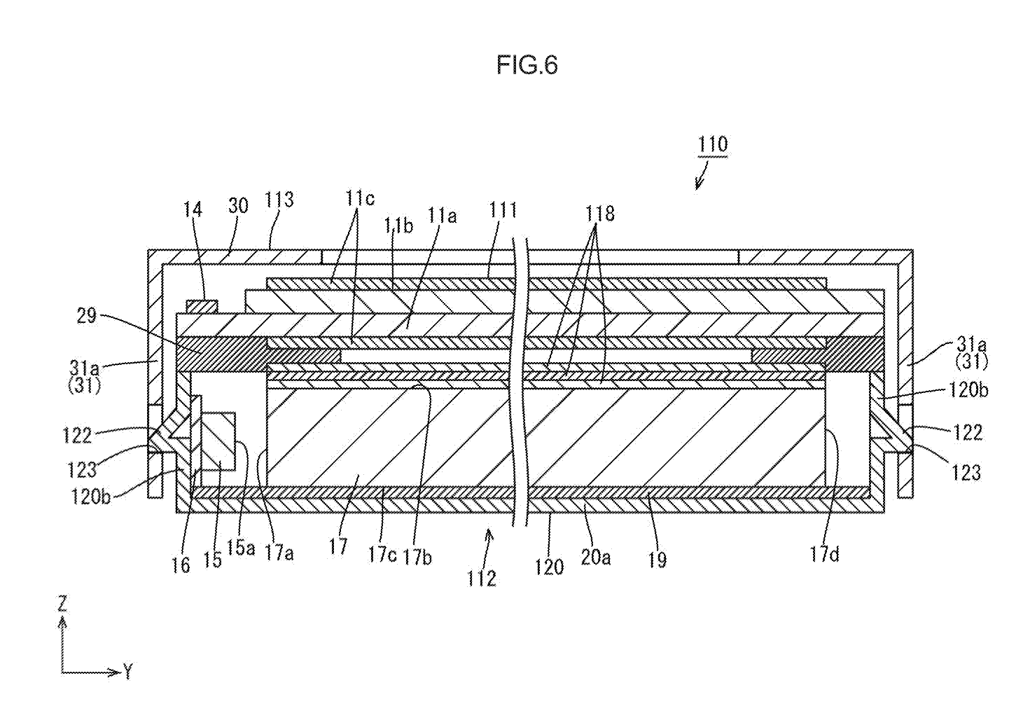

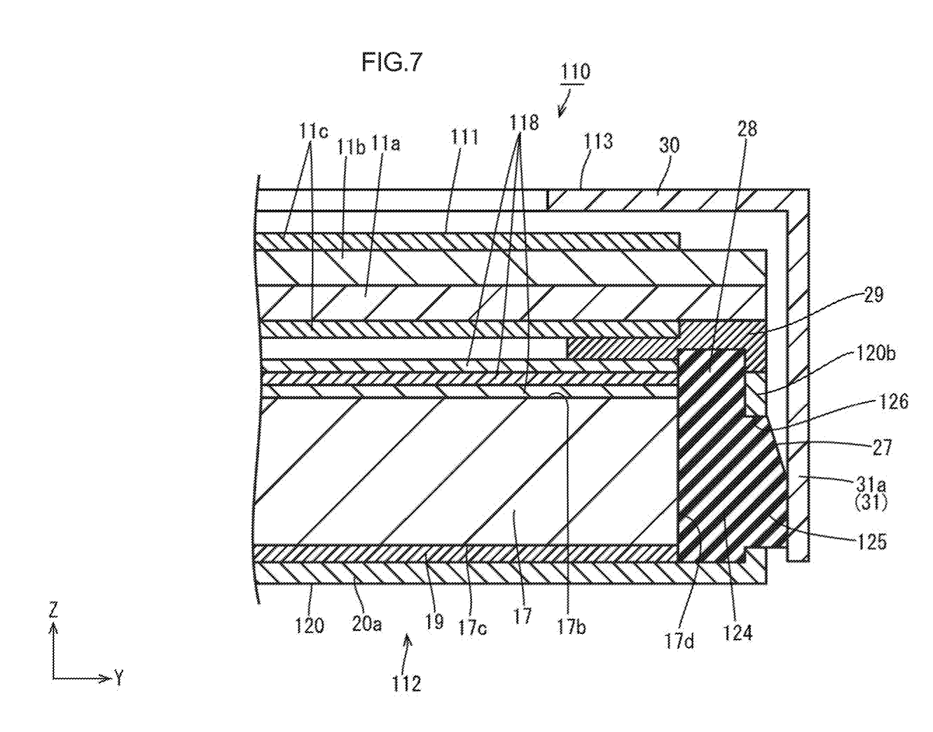

A second embodiment of the present, invention will be described with reference to FIG. 6 or FIG. 7. In the second embodiment, a configuration will be presented in which the frame 21 according to the first embodiment is omitted. Redundant descriptions of structures, operations, or effects similar to those of the first embodiment will be omitted.

A backlight device 112 according to the present embodiment, as illustrated in FIG. 6, is not provided with the frame 21 as according to the first embodiment. Instead, a panel fixing member 29 is provided. The panel fixing member 29 has a horizontally long frame-like shape in conformity with the outer peripheral end portion of the liquid crystal panel 111. The panel fixing member 29 is interposed between the liquid crystal panel 111 and the sheets provided in the backlight device 112, with respect to the Z-axis direction. The panel fixing member 29 is made of, e.g., a light-shielding double-side tape including a light-shielding base material having an adhesive material applied to both surfaces thereof. The panel fixing member 29 fixes the liquid crystal panel 111 and the backlight device 112 to each other with the adhesive material on the front side of the base material fixedly attached to the liquid crystal panel 111, and with the adhesive material on the back side of the base material being fixedly attached to the sheets (optical sheet 118 at the top) and the inner frame-shaped portion 120b of the chassis 120.

The configuration of a bezel (paned pressing member) 113 will be described. The bezel 113 is made of metal, similarly to the chassis 120. As illustrated in FIG. 6, the bezel 113 includes a panel pressing portion 30 that presses the liquid crystal panel 111 from the front side, and an outer frame-shaped portion 31 that protrudes from the outer peripheral end of the panel pressing portion 30 toward the back side (opposite side from the light exiting side) and has a short cylindrical shape. Thus, generally, the bezel 113 has a horizontally long frame-like shape. The panel pressing portion 30 has a frame shape with a certain width such that the internal dimension of each side is substantially the same as or greater than the length of each side of the display region of the liquid crystal panel 111, and such that the outer dimension of each side is greater than the outer dimension of each side of the liquid crystal panel 111. The panel pressing portion 30 presses the outer peripheral end portions (non-display region) of the liquid crystal panel 111 from the front side along the entire periphery. The outer frame-shaped portion 31 when viewed in plan has a horizontally long and rectangular frame-like shape, and includes a pair of long-side portions 31a and a pair of short-side portions (not illustrated) which are perpendicular to each other. The outer frame-shaped portion 31 surrounds the inner frame-shaped portion 120b so as to overlap the outer side of the inner frame-shaped portion 120b of the chassis 120. The outer frame-shaped portion 31 has inner peripheral surfaces opposing the outer peripheral surfaces of the inner frame-shaped portion 120b along the entire periphery. Between the outer frame-shaped portion 31 and the inner frame-shaped portion 120b, a gap is provided to absorb assembly tolerances between the bezel 113 and the chassis 120. According to the configuration, ease of assembly of the bezel 113 with respect to the chassis 120 is ensured.

As illustrated in FIG. 6, the outer frame-shaped portion 31 of the bezel 113, similarly to the outer frame-shaped portion 21b of the frame 21 according to the first embodiment (see FIG. 2 and FIG. 3) , has lock openings 123 formed penetrating therethrough. Into the lock openings 123, locking nail portions 122 with which the inner frame-shaped portion 120b of the chassis 120 are provided enter and become locked on the back side portion of the opening edge, whereby the bezel 113 is held with respect to the chassis 120. Between the internal dimension of the lock openings 123 and the outer dimension of the locking nail portions 122, a certain dimensional difference is ensured as in the first embodiment. According to the configuration, regardless of the presence or absence or manufacturing error, for example, the fixing function of the lock openings 123 and the locking nail portions 122 can be reliably exploited.

As illustrated in FIG. 7, an elastic abutment portion 125 with which a light guide plate holding portion 124 is provided is elastically abutted, through a through-hole 126 formed penetrating through the inner frame-shaped portion 120b of the chassis 120, against the outer frame-shaped portion 31 of the bezel 113. Due to the elastic abutment portion 125, the inner frame-shaped portion 120b of the chassis 120 and the outer frame-shaped portion 31 of the bezel 113 are elastically held in a state in which a gap is provided between the mutually opposing surfaces thereof. Accordingly, if the chassis 120 and the bezel 113 are not tightly fitted to each other due to assembly tolerances or due to dimensional difference between the locking nail portions 122 and the lock openings 123 and the liquid crystal display device 110 is vibrated, the outer frame-shaped portion 31 and the inner frame-shaped portion 120b are less likely to generate noise.

As described above, according to the present embodiment, the bezel (panel pressing member) 113 presses the liquid crystal panel 111 from the opposite side to the backlight device 112 side, the bezel 113 including the outer frame-shaped portion 31. According to the configuration, even in the configuration in which the bezel 113 that presses the liquid crystal panel 111 from the opposite side to the backlight device 112 side has the outer frame-shaped portion 31, having the elastic abutment portion 125 with which the light guide plate holding portion 124 is provided elastically abutted against the outer frame-shaped portion 31, the outer frame-shaped portion 31 and the inner frame-shaped portion 120b become less likely to contact each other, whereby the generation of noise is suppressed.

### Third Embodiment

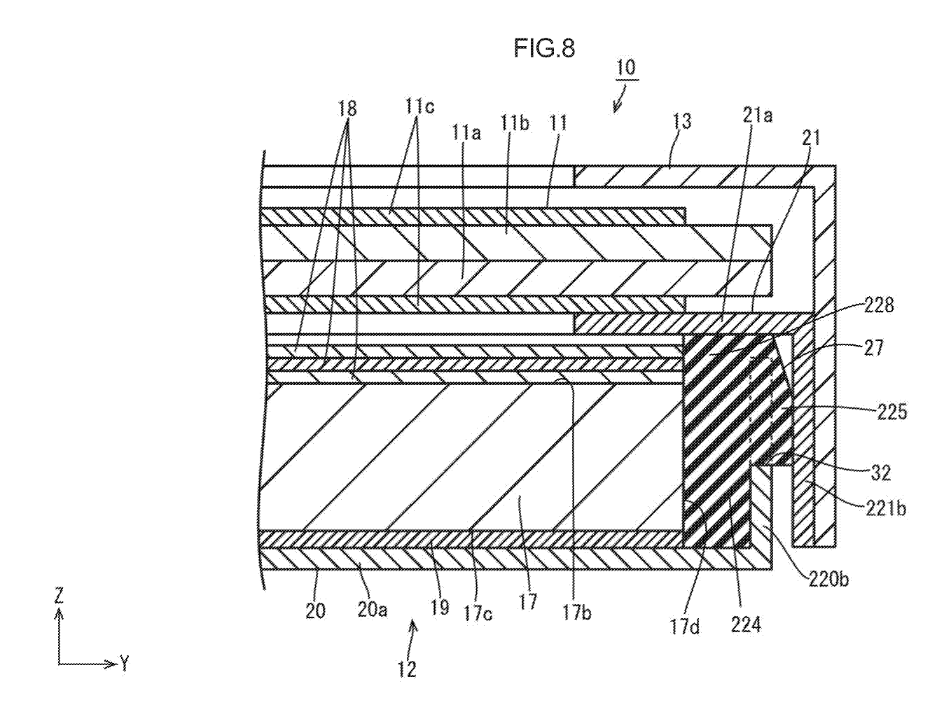

A third embodiment of the present invention will be described with reference to FIG. 8. In the third embodiment, the configuration of inner frame-shaped portion 220b and elastic abutment portion 225 is modified from that of the first embodiment. Redundant descriptions of structures, operations, or effects similar to those of the first embodiment will be omitted.

As illustrated in FIG. 8, an inner frame-shaped portion 220b according to the present embodiment is formed with a cut-out portion 32 for passing an elastic abutment portion 225. The cut-out portion 32 is formed by partially cutting out the inner frame-shaped portion 220b so as to be open in the Z-axis direction on the front side. Accordingly, the opening edge of the cut-out portion 32 of the inner frame-shaped portion 220b does not have a front side part, as does in the first embodiment. The elastic abutment portion 225 is continuous not only with the light guide plate holding portion 224 but also with a pressing portion-side elastic abutment portion 228, and is elastically abutted against an outer frame-shaped portion 221b on the outside through the cut-out portion 32.

### Other Embodiments

The present invention is not limited to the embodiments described above with reference to the drawings, and the following exemplary embodiments are also included in the technical scope of the present invention.

(1) In the foregoing embodiments, through-holes and cut-out portions are provided to pass an elastic abutment portion into the inner frame-shaped portion. However, the through-holes and the cut-out portions may be omitted. In this case, for example, the elastic abutment portion may be provided so as to be continuous not with the light guide plate holding portion but only with the pressing portion elastic abutment portion. In other examples, the height of the inner frame-shaped portion (the rising dimension from the light guide plate receiving portion) may be generally decreased such that the elastic abutment portion is installed at a position higher than the inner frame-shaped portion (front side position).

(2) Other than as described in the foregoing embodiments, it is also possible to modify, as appropriate, the specific shape, range of formation, the number of installations, arrangement and the like of the elastic abutment portion at the light guide plate holding portion. It is also possible to modify, as appropriate, the specific shape, range of formation, the number of installations, arrangement, and the like of the through-holes or cut-out portions.

(3) Other than as described in the foregoing embodiments, it is also possible to provide both a through-hole and a cut-out portion in the inner frame-shaped portion.

(4) Other than as described in the foregoing embodiments, it is possible to modify, as appropriate, the specific planar shape and planar arrangement of the light guide plate holding portion. For example, the light guide plate holding portion may include only the first holding portion or include only the second holding portion. In this case, the light guide plate holding portion may be abutted against the end surface at a corner portion of the light guide plate, However, it is also possible to adopt a planar arrangement in which the light guide plate holding portion is abutted against an end surface at a portion other than a corner portion of the light guide plate.

(5) Other than as illustrated with reference to the foregoing embodiments, it is possible to modify, as appropriate, the specific number of installations, planar arrangement, cross sectional shape and the like of the light guide plate holding portion of the backlight device.

(6) In the foregoing embodiments, the case has been described in which the elastic abutment portion is integrally formed with the light guide plate holding portion. However, the elastic abutment portion may be attached to the light guide plate holding portion separately from the light guide plate holding portion. In this case, the elastic abutment portion and the light guide plate holding portion may include different materials. For example, the elastic abutment portion may include but is not limited to a spring material.

(7) The specific material of the light guide plate holding portion and the elastic abutment portion is not limited to the rubber material as in the foregoing embodiments, but may include gel material or gelatinous material, for example.

(8) In the foregoing embodiments, the configuration has been described in which the chassis includes the inner frame-shaped portion, and the frame or the bezel includes the outer frame-shaped portion. However, the configuration may be adopted in which the chassis includes the outer frame-shaped portion and the frame or the bezel includes the inner frame-shaped portion.

(9) In the foregoing embodiments, the case has been described in which a pair of light guide plate holding portions is installed so as to hold a pair of corner portions of the light guide plate. However, it is possible to install a single light guide plate holding portion for holding a corner portion.

(10) In the foregoing embodiments, the configuration has been described in which the light guide plate includes a position regulating portion. However, in is of course possible to use a light guide plate having no position regulating portion. In this case, it is possible to provide four light guide plate holding portions configured to respectively hold the corner portions at the four corners of the light guide plate. It is also possible to provide three light guide plate holding portions configured to respectively hold arbitrary three corner portions among the corner portions at the four corners of the light guide plate.

(11) In the foregoing embodiments, the case has been described in which the chassis includes the light guide plate receiving portion. However, the configuration may be adopted in the chassis only includes the inner frame-shaped portion surrounding the light guide plate.

(12) In the foregoing embodiments, a fixing structure including a locking nail portion and a lock opening has been described. However, the chassis and the frame or the bezel may be fixed together using other means.

(13) In the foregoing embodiments, the configuration has been described in which the elastic abutment portion is provided with an inclined surface. However, it is possible to omit the inclined surface.

(14) In the foregoing embodiments, the configuration has been described in which the light guide plate holding portion is provided with a pressing portion-side elastic abutment portion. However, it is also possible to omit the pressing portion-side elastic abutment portion.

(15) The present invention is also applicable to a liquid crystal display device in which the frame according to the first embodiment and the bezel according to the second embodiment are present. In this case, the elastic abutment portion may be abutted against both the outer frame-shaped portion of the frame and the outer frame-shaped portion of the bezel. Alternatively, the elastic abutment portion may be abutted only against one of the outer frame-shaped portions.

(16) Other than as described in the foregoing embodiments, it is possible to modify, as appropriate, the specific number or type of the optical sheets used in the backlight device.

(17) Other than as described in the foregoing embodiments, the reflection sheet covering the opposite plate surface of the light guide plate may be omitted.

(18) Other than as described in the foregoing embodiments, it is possible to modify, as appropriate, the number of LEDs mounted on the LED substrate.

(20) In the foregoing embodiments, the top light-emitting type LEDs have been described. However, it is also possible to use side-emission type LEDs as the light source. It is also possible to use a light source other than LEDs (such as organic EL).

(21) In the foregoing embodiments, a liquid crystal display device provided with a liquid crystal panel as the display panel has been described. However, the present invention is also applicable to a micro electro mechanical systems (MEMS) display device provided with a MEMS display panel as the display panel.

### EXPLANATION OF SYMBOLS

10, 110: Liquid crystal display device (Display device)
11, 111: Liquid crystal panel (Display panel)
12, 112: Backlight device (Lighting device)
15: LED (Light source)
17: Light guide plate
17a: Light entering end surface
17b: Light exiting plate surface
17d: Non-light entering end surface (End surface)
17CN: Corner portion
20a: Light guide plate receiving portion
20b, 120b, 220b: Inner frame-shaped portion
21a: Light guide plate pressing portion
21b, 221b: Outer frame-shaped portion
22, 122: Locking nail portion
23, 123: Lock opening
24, 124, 224: Light guide plate holding portion
24a: First holding portion
24b: Second holding portion
25, 125, 225: Elastic abutment portion
26, 126: Through-hole
27: inclined surface
28, 228: Pressing portion-side elastic abutment portion
31: Outer frame-shaped portion
113: Bezel (Panel pressing member)

1. A lighting device comprising:
a light source;
a light guide plate including an outer peripheral end surface and a pair of plate surfaces, the outer peripheral end surface including an end surface opposed to the light source and defined as a light entering end surface through which light enters, one of the plate surfaces being defined as a light exiting plate surface through which the light exits;
an inner frame-shaped portion opposed to the outer peripheral end surface to surround the light guide plate;
a light guide plate holding portion disposed between at least a part of the outer peripheral end surfaces of the light guide plate and the inner frame-shaped portion to hold the light guide plate;
an outer frame-shaped portion surrounding the inner frame-shaped portion to overlap an outer side of the inner frame-shaped portion; and
at least one elastic abutment portion on the light guide plate holding portion and elastically abutted against the outer frame-shaped portion.

2. The lighting device according to claim 1, wherein
the inner frame-shaped portion includes a through-hole, and
the at least one elastic abutment portion is abutted against the outer frame-shaped portion through the through-hole.

3. The lighting device according to claim 1, wherein
the light guide plate includes a corner portion defined by two end surfaces included in the outer peripheral end surface, the two end surfaces being perpendicular to each other, and
the light guide plate holding portion includes a first holding portion abutted against one of the two end surfaces that define the corner portion and a second holding portion abutted against another one of the two end surfaces, the first holding portion and the second holding portion being connected to each other, and
the at least one elastic abutment portion includes elastic abutment portions on the first holding portion and the second holding portion.

4. The lighting device according to claim 1, further comprising:
a light guide plate receiving portion coupled with one of the inner frame-shaped portion and the outer frame-shaped portion to receive the light guide plate from a side opposite from the light exiting plate surface side; and
a light guide plate pressing portion coupled with the other of the inner frame-shaped portion and the outer frame-shaped portion to press the light guide plate from the light exiting plate surface side.

5. The lighting device according to claim 4, the light guide plate holding portion is provided with a pressing portion-side elastic abutment portion which protrudes from the light exiting plate surface of the light guide plate and is abutted against the light guide plate pressing portion.

6. The lighting device according to claim 4, wherein
the light guide plate receiving portion is coupled with the inner frame-shaped portion,
the light guide plate pressing portion is coupled with the outer frame-shaped portion, and
the elastic abutment portion includes an inclined surface in an outer surface of the elastic abutment portion, the inclined surface being configured such that a distance from the outer frame-shaped portion decreases as a distance from the light exiting plate surface with respect to a normal direction of a plate surface of the light guide plate increases.

7. The lighting device according to claim 1, wherein
one of the inner frame-shaped portion and the outer frame-shaped portion includes a lock opening, and
the other one of the inner frame-shaped portion and the outer frame-shaped portion includes a locking nail portion disposed in the lock opening and locked on an opening edge of the lock opening.

8. A display device comprising:
the lighting device according to claim 1; and
a display panel configured to display an image using light from the lighting device.

9. The display device according to claim 8, further comprising a panel pressing member for pressing the display panel from a side opposite from the lighting device side,
wherein the panel pressing member includes the outer frame-shaped portion.
